(19) United States
(12) Patent Application Publication
(10) Pub. No.: US 2013/0338711 A1
(43) Pub. Date: Dec. 19, 2013

(54) FROZEN PACIFIER AND TEETHER

(71) Applicant: Monica B. Strazzeri, Lehi, UT (US)

(72) Inventor: Monica B. Strazzeri, Lehi, UT (US)

(21) Appl. No.: 13/527,135

(22) Filed: Jun. 19, 2012

(51) Int. Cl. A61J 17/02; B29C 35/16

(52) U.S. Cl. 606/235; 264/28

(57) ABSTRACT

A pacifier system includes a pacifier having a face shield, a teething member, and a handle. The face shield includes first and second sides. The first side has a concave surface. The teething member extends from the concave surface on the first side of the face shield. The handle extends from the second side of the face shield. The pacifier system also includes a frozen member mold having a cavity that is sized to hold a volume of frozen fluid and receives the teething member held within the frozen fluid. The teething member is configured to maintain connection with the frozen fluid. The pacifier is removable from the frozen member mold with the frozen fluid attached to the teething member. The frozen fluid is insertable into a child's mouth to pacify the child and the teething member is configured to be chewed after the frozen fluid is removed.

### TECHNICAL FIELD

The present systems and methods relate to pacifiers and teethers. More particularly, present systems and methods relate to pacifiers and teethers having a frozen portion.

### BACKGROUND

Pacifiers have been used for many years to help sooth or pacify a baby. Some types of pacifiers include a pacifying nipple and a teething ring positioned opposite the nipple to provide both pacifying and teething functions for the baby. Pacifier nipples are typically hollow and hold a sealed volume of air.

Some teething rings hold fluid or comprise materials that retain cold temperatures when stored in a cold environment. The cold teething ring may provide additional comfort for a baby with swollen gums when teething.

Babies and small children are sometimes prone to receive facial injuries that result from, for example, learning to crawl or walk. Injuries to a baby's mouth can be particularly difficult to treat with cold compresses or ice because the child is uncooperative and does not understand the benefit of such treatment.

Further, a number of problems exist related to giving medication or fluids to a child orally. Some babies and small children are very resistant to other people putting things into their mouth, even when such things are intended for the child's improved health or care.

There is a need for improvements in treating oral injuries in children and oral delivery of medications and fluids to children that is convenient and easy to use.

### SUMMARY

One aspect of the present disclosure relates to a pacifier system that includes a pacifier and a frozen member mold. The pacifier includes a face shield, a teething member, and a handle. The face shield includes a first side and a second side, wherein the first side has a concave surface. The teething member extends from the concave surface on the first side of the face shield. The handle extends from the second side of the face shield. The frozen member mold includes a cavity that is sized to hold a volume of frozen fluid and receives the teething member held within the frozen fluid. The teething member is configured to maintain a connection with the frozen fluid. The pacifier is removable from the frozen member mold with the frozen fluid attached to the teething member. The frozen fluid is insertable into a child's mouth to pacify the child and the teething member is configured to be chewed after the frozen fluid is removed.

The teething member may include a plurality of protrusions on an exterior surface thereof. The frozen fluid may have a tapered shape. The cavity may have a nipple shape. The handle may comprise a loop-shaped portion. The face shield may be configured to contact an outer facial surface of the child when the frozen fluid is inserted into the child's mouth. The frozen member mold may include a plurality of cavities and a plurality of pacifier interfaces. The teething member may include a food grade silicone. The cavity may have a bulbous shape. The frozen member mold may include a pacifier interface configured to support the pacifier and orient the teething member within the cavity.

Another aspect of the present disclosure relates to a pacifier that includes a face shield, a teething member, a handle, and a frozen fluid. The face shield may include a first side and a second side, wherein the first side is configured to contact lips or a facial surface of a child adjacent to a mouth of the child. The teething member extends from the first side of the face shield and has an exterior surface. The handle extends from the second side of the face shield and includes a grasping portion. The frozen fluid is mounted to the exterior surface of the teething member and has a nipple shape. The teething member includes a structure that retains the frozen fluid on the outer surface of the teething member.

The teething member may include a plurality of protrusions formed on the exterior surface thereof. The frozen fluid may include at least one of a medication, a flavor, a color, water and a juice. The teething member may include silicone. The first side of the face shield may include a concave surface and a plurality of holes formed in the concave surface. The pacifier may be integrally formed as a single piece.

A further aspect of the present disclosure relates to a method of manufacturing a frozen pacifier. The method includes forming a pacifier that includes a face shield, a teething member extending from a first side of the face shield, and a handle extending from a second side of the face shield. The method may also include forming a mold comprising a mold cavity, wherein the mold cavity is configured to be filled with a liquid and to receive the teething member. A liquid in the mold cavity is frozen to form a frozen liquid that is secured to the teething member. The frozen liquid is removed from the mold cavity while secured to the teething member and configured for insertion into a child's mouth. The teething member is configured to be chewed within the child's mouth after the frozen liquid is removed from the teething member.

The method may include releasably connecting the pacifier to the mold while freezing the liquid. The method may include integrally forming the pacifier as a single piece. The method may include forming the frozen liquid with a bulbous shape.

Another example method in accordance with the present disclosure relates to a method of using a pacifier system. The method includes providing a pacifier and a mold, wherein the pacifier includes a face shield, a teething member extending from a first side of the face shield, and a handle extending from a second side of the face shield. The mold includes a mold cavity having a nipple shape that is sized to fit within a child's mouth. The method may also include filling the mold cavity with a liquid, inserting a teething member into the mold cavity, freezing the liquid into a frozen liquid that is secured to the teething member, removing the teething member with the frozen liquid from the mold cavity, inserting the frozen liquid into the child's mouth to treat the child's mouth, removing the frozen liquid, and chewing on the teething member with the child's mouth after removing the frozen liquid. Removing the frozen liquid may include thawing the frozen liquid in the child's mouth.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a perspective view of an example pacifier system in accordance with the present disclosure.

FIG. 2 is a perspective view of a pacifier of the pacifier system of FIG. 1.

FIG. 3 is a perspective view of the pacifier of FIGS. 1 and 2 with a frozen member mounted thereon.

FIG. 4 is a front view of the pacifier of FIG. 2.

FIG. 5 is a rear view of the pacifier of FIG. 2.

FIG. 6 is a cross-sectional view of the pacifier of FIG. 4.

FIG. 7 is a front view of the pacifier with the frozen member of FIG. 3.

FIG. 8 is a cross-sectional view of the pacifier and the frozen member of FIG. 7.

FIG. 9 is a front view of another example pacifier with the frozen member in accordance with the present disclosure.

FIG. 10 is a cross-sectional view of the pacifier and the frozen member of FIG. 9.

FIG. 11 is a cross-sectional view of the pacifier system of FIG. 1 and the pacifier of FIG. 9.

Throughout the drawings, identical reference numbers designate similar, but not necessarily identical, elements.

### DETAILED DESCRIPTION

The present disclosure relates to pacifiers, teethers, pacifiers having teething features, pacifiers with frozen members mounted thereon, molds used for frozen pacifiers, pacifier systems that include pacifiers and molds, and related methods. One aspect of the present disclosure relates to systems and methods for forming a frozen pacifier, or at least a pacifier having a frozen portion mounted on the exterior surface thereof. The frozen portion may comprise a liquid such as water, juice, or hydrating material that is solidified into a size and shape that fits within a child's mouth. A portion of the pacifier to which the frozen member is mounted on an exterior surface thereof may be configured as a teething member that the child can chew upon after the frozen member has been removed (e.g., by thawing within the child's mouth).

The frozen pacifier and related pacifier system and methods disclosed herein may have certain advantages over other types of pacifiers and teething structures. The frozen pacifiers of the present disclosure incorporate a pacifier construction that is visually identified by a child as an object that provides comfort that will soothe the child. The pacifier is provided with a teething portion so that the child may chew upon the teething portion to encourage teething in the child's mouth. The teething member may be exposed after the frozen member is removed from the pacifier. The teething member may provide a substrate or structure upon which the frozen member is connected to the pacifier. In one example, the teething member includes a plurality of protrusions, dimples, shapes and sizes that promote insertion of the teething member into a child's mouth and encourage chewing on the teething member by the child. The structure and features on an exterior surface of the teething member may also promote connection of the frozen member to the pacifier.

The frozen member may have a shape and size similar to the nipple of a typical pacifier. In one example, the frozen member has a bulbous shape. Other examples include a cylindrical shape with a rounded end portion and a slightly tapered sidewall. The frozen member typically has a length that provides comfortable insertion into a child's mouth until a face shield portion of the pacifier contacts the lips and other facial tissues surrounding the mouth of the child. The frozen member may be sized for different aged children such as, for example, an infant (ages 0-12 months), a toddler (ages 1-3 years), and an older child (ages 4-8 years).

An example pacifier system may include a mold used to form the frozen member onto the teething member of the pacifier. The mold may include a plurality of cavities. The cavities may have different shapes and sizes to provide frozen members of different shapes and sizes.

The frozen member may be used to hydrate a child that otherwise cannot or will not drink or ingest fluids. The shape and appearance of the frozen member in combination with the pacifier features of a face shield and handle may promote acceptance and use of the frozen pacifier by the child, which results in intake of liquids as the frozen member is thawed in the child's mouth. The frozen member may provide a mechanism for delivery of a medication to the child. The frozen member may include flavors, colors, aromas, and other characteristics that promote use by the child.

The frozen member may also be used for treating a child that would not otherwise permit contact of a frozen object (e.g., an ice cube or ice pack) in close proximity to the child's mouth. For example, the frozen member may be used as an ice compact for a child that has received a mouth injury such as an injury to lips, gums, tongue, teeth, or palate of the child. The frozen member can be applied to the injured tissue by the child or by an adult either on an exterior facial surface of the child (e.g., on lips or facial tissues surrounding the mouth) or within the child's mouth (e.g., gums, tongue or palate). The frozen member may be shaped with contoured surfaces that provide comfortable, smooth motion over the child's facial tissue. The nipple shape of the frozen member may also induce sucking on the frozen member by the child.

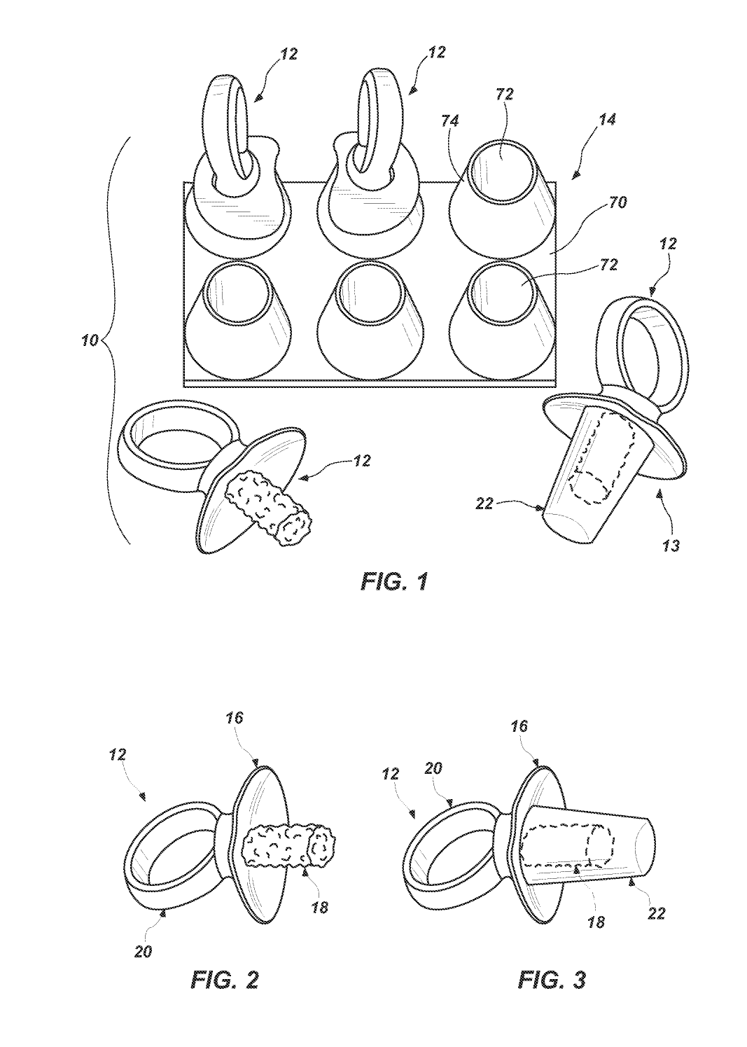

Referring now to FIGS. 1-8, an example pacifier system 10 is shown including a pacifier 12 and a mold 14. The pacifier system 10 may include a plurality of pacifiers 12 of different shapes and sizes. The mold 14 may include a plurality of cavities each sized to receive a different one of the pacifiers. The cavities may have different shapes and sizes to provide various shaped and sized frozen members attached to the pacifier. Typically, the cavities of the mold 14 are at least partially filled with a fluid. A portion of the pacifiers 12 are inserted into the cavities of the mold into contact with the fluid. The pacifier system 10 is then placed in a cold environment such as a freezer wherein the liquid is frozen to form a frozen member that is attached to the pacifiers. The pacifiers 12 with frozen members 22 are removed from the cavities of mold 14 to provide a frozen pacifier 13 as shown in FIG. 1.

The pacifier 12 includes a face shield 16, a teething member 18, and a handle 20. The face shield includes front and rear surfaces 30, 32. The teething member 18 extends from the front surface 30 and the handle 20 extends from the rear surface 32. The front surface 30 may be curved or contoured, and may have a concave shape (see FIG. 6). The curvature of the front surface 30 may match a typical curvature of a child's face in the area around a mouth of the child.

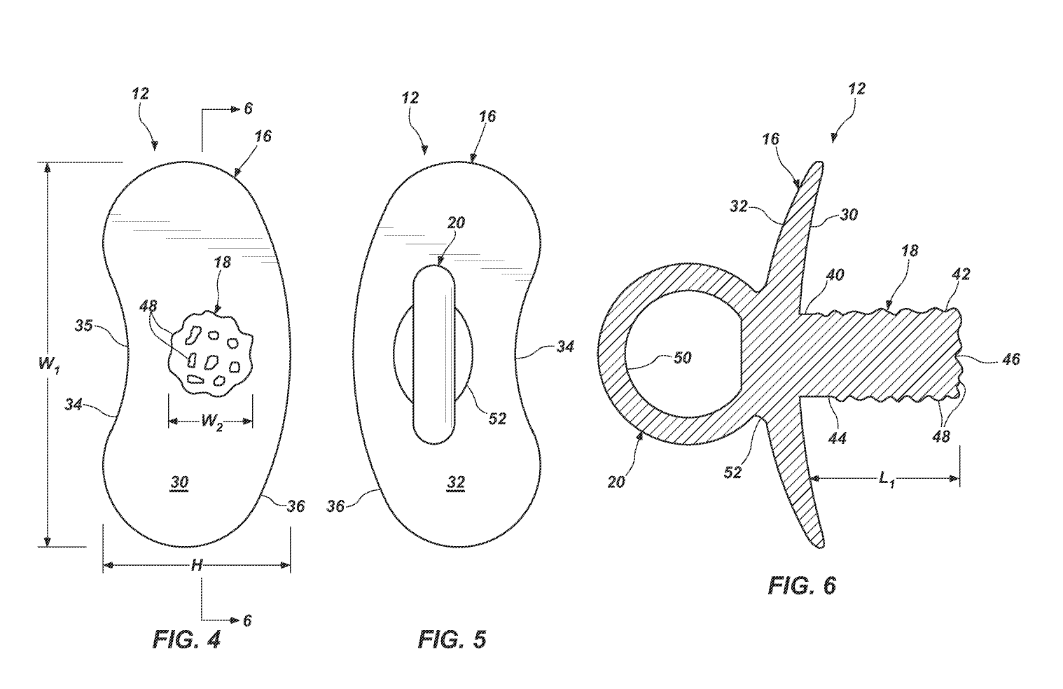

The face shield 16 may also include a top edge 34 and a bottom edge 36. The top edge 34 may include a recess 35 in the area where the top edge 34 typically would otherwise contact a nose of the child (see FIG. 4). The face shield 16 may have a width W₁ and a height H as shown in FIG. 4. The width W₁ may be greater than the height H. The width W₁ of the face shield is typically in the range of about 1 inch to about 3 inches, and more preferably about 2 inches. The height H is typically in the range of about 1 inch to about 2 inches, and more preferably in the range of about 1.25 to about 1.5 inches.

The teething member 18 may include proximal and distal ends 40, 42, side and end surfaces 44, 46, and a plurality of projections 48 formed on the side and end surfaces 44, 46 (see FIGS. 4 and 6). In some arrangements, at least some of the projections 48 may be replaced by a plurality of recesses such as dimples. The side surface 44 is shown in FIG. 6 being relatively straight and extending perpendicular from the front surface 30 of the face shield 16. In other examples, the teething member 18 may have different shapes and sizes such as a bulbous shape, a tapered shape, a spherical shape, etc.

The teething member 18 may extend a length L₁ from the front surface 30 to face shield 16. Typically, the length L₁ is selected to be adequate for use with children having a range of mouth sizes (e.g., infants, toddlers, or older children). The length L₁ is typically no greater than a depth of a mouth cavity of the child so that the teething member 18 does not create a choking hazard for the child. The length L₁ of the teething member 18 is typically in the range of about 0.5 inch to about 1.5 inches, and more preferably in the range of about 1 inch to about 1.5 inches.

The teething member 18 may have a width W₂ that permits insertion into the child's mouth. The width W₂ (see FIG. 4) is typically in the range of about 0.25 inches to about 0.75 inches, and more preferably in the range of about 0.5 inches to about 0.625 inches.

The projections 48 or other surface features on the side and end surfaces 44, 46 may promote chewing of the teething member 18 by the child. Chewing on the teething member 18 may be desirable for children who are trying to cut teeth through their gums. Chewing on the teething member 18 may help wear through the gum tissue so that the cutting teeth are exposed. The surface features of the teething member 18 may be configured (e.g., sized, shaped, and arranged) to make the teething member 18 more desirable for a child to insert into its mouth and chew upon.

The handle 20 may include a handle opening 50 and a handle connection portion 52. The handle opening 50 may create a loop structure in the handle 20 so that the handle 20 is easier to grasp for purposes of carrying or maneuvering the pacifier 12. The handle connection portion 52 may be secured to the rear surface 32 of the face shield 16. In some arrangements, the handle 20 is connected directly to the teething member 18 and may be integrally formed with the teething member 18. The face shield may be separately attached to one of the handle 20 and teething member 18.

In at least some arrangements, the entire pacifier 12 may be integrally formed as a single piece as shown in FIG. 6. In other arrangements, portions of the pacifier 12 may be formed separate from the other portions and later assembled during manufacturing. For example, the handle 20 may be formed separate from the face shield 16 and teething member 18 and connected in a later assembly step using a connection method such as, for example, an adhesive, heat welding, or a snap-fit connection.

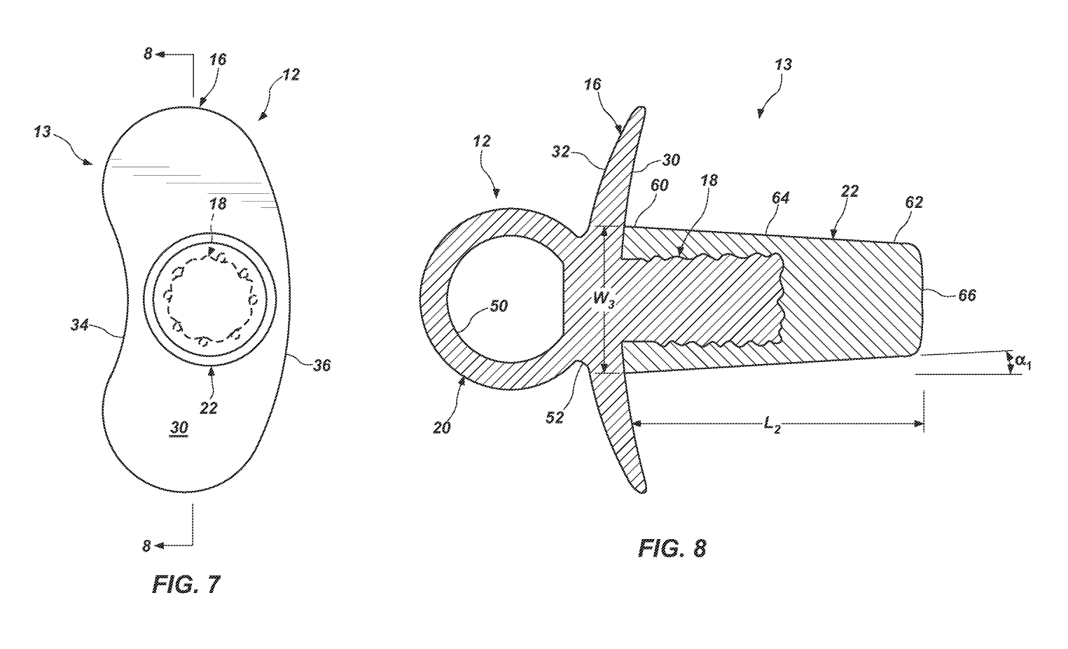

Referring now to FIGS. 7 and 8, an example frozen pacifier 13 is shown including the pacifier 12 and an additional frozen member 22 mounted thereto. The frozen member 22 includes proximal and distal ends 60, 62, side and end surfaces 64, 66, a length L₂, and a maximum width W₃. The length L₂ is typically no greater than a depth of a mouth cavity of the child so that the frozen member 22 does not create a choking hazard for the child. The length L₂ of the frozen member 22 is typically in the range of about 1 inch to about 2.5 inches, and more preferably in the range of about 1 inch to about 2 inches. The frozen member 22 may have a maximum width W₃ that permits insertion into the child's mouth. The width W₃ (see FIG. 7) is typically in the range of about 0.5 inches to about 1.5 inches, and more preferably in the range of about 0.5 inches to about 1 inch.

Typically, the length L₂ is greater than the length L₁ of the teething member 18, and the width W₃ is greater than the width W₂ of the teething member 18 so that the entire teething member 18 is encapsulated within the frozen member 22. Encapsulating the teething member 18 within the frozen member 22 may also provide improved connection between the frozen member 22 and the teething member 18. In some arrangements, portions of the teething member 18 may be exposed outside of the frozen member 22 prior to using the frozen pacifier 13 with a child.

The frozen member 22 may have a tapered construction with a taper angle α₁. The taper angle α₁ may be in the range of, for example, about 2° to about 20°, and more preferable in the range of about 2° to about 10°. The tapered shape of the frozen member 22 may promote easy removal of the frozen pacifier 13 from the mold 14.

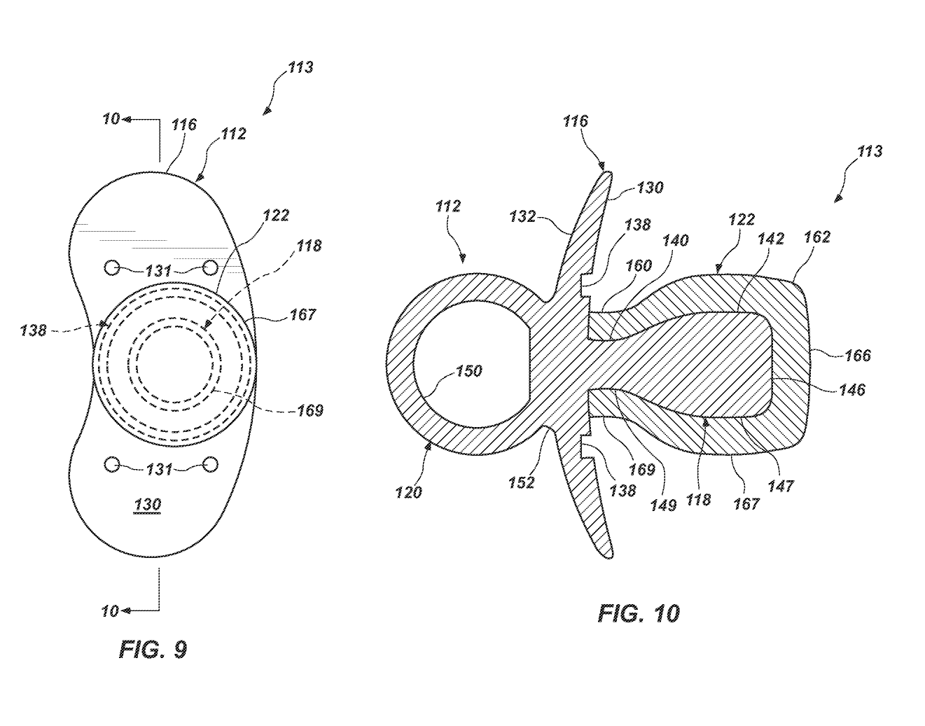

Many other shapes and sizes are possible for the frozen member 22. In one example, the frozen member 22 has a bulbous shape as shown in, for example, FIGS. 9 and 10. The frozen member 22 may have a negative taper angle with an increasing width towards the distal end 62. The frozen member 22 may have contoured shapes and smooth surfaces to promote easy insertion into a child's mouth. Alternatively, the frozen member 22 may have a plurality of planar surfaces and angular shapes. The frozen member 22 may have a nipple shape such as a nipple shape of pacifiers typically sold in the industry.

Although not shown, the frozen member 22 may have a plurality of projections, recesses, serrations, or divots formed in the side and end surfaces 64, 66. The surface features of the frozen member 22 may assist in treating or soothing a child by contacting exterior facial tissue or placing the frozen member 22 within the child's mouth. The surface features of the frozen member 22 may have aesthetic benefits such as, for example, making the frozen member 22 more attractive for a child to insert into its mouth.

Referring now to FIGS. 9 and 10, another example pacifier 112 is shown having a frozen member 122 mounted therein to form a frozen pacifier 113. The pacifier 112 includes a face shield 116, a teething member 118, and a handle 120. The face shield 116 includes front and rear surfaces 130, 132 (see FIG. 10), with the teething member 118 extending from the front surface 130 and the handle 120 extending from the rear surface 132. A plurality of holes 131 may be formed in the face shield 116 to permit air to pass from the front surface 130 to the rear surface 132. The teething member 118 may include proximal and distal ends 140, 142, an end surface 146, a bulb portion 147 at the distal end 142, and a base portion 149 at the proximal end 140. The base portion 149 connects the teething member 118 to the face shield 116. The handle 120 includes a handle opening 150 and a handle connection portion 152 for connection of the handle 120 to the rear surface 132 of the face shield 116.

The frozen member 122 may include proximal and distal ends 160, 162, an end surface 166, a bulb portion 167, and a base portion 169. The frozen member 122 may have a shape that corresponds to or mirrors the shape of the teething member 118. In other arrangements, the teething member 118 and frozen member 122 may have different shapes. For example, the teething member 118 may have a generally cylindrical shape with a circular cross-section as shown in FIGS. 1-8, and the frozen member 122 may have a generally bulbous shape as shown in FIGS. 9 and 10. The bulbous shape of the teething member 118 may assist in retaining the frozen member 122 on an outer surface thereof The teething member 118 may include other shapes, sizes, and surface features that assist in maintaining the frozen member 122 mounted to the teething member 118.

The pacifier 112 may include at least one alignment recess 138 formed in the front surface 130 of the face shield 116. The alignment recesses 138 may be used to align the pacifier 112 with features of the mold 14 as will be described in further detail below. Other alignment features besides recesses may be used in place of the alignment recesses 138 including, for example, projections, clips, or interference fits that provide at least one of alignment and connection of the pacifier relative to the mold.

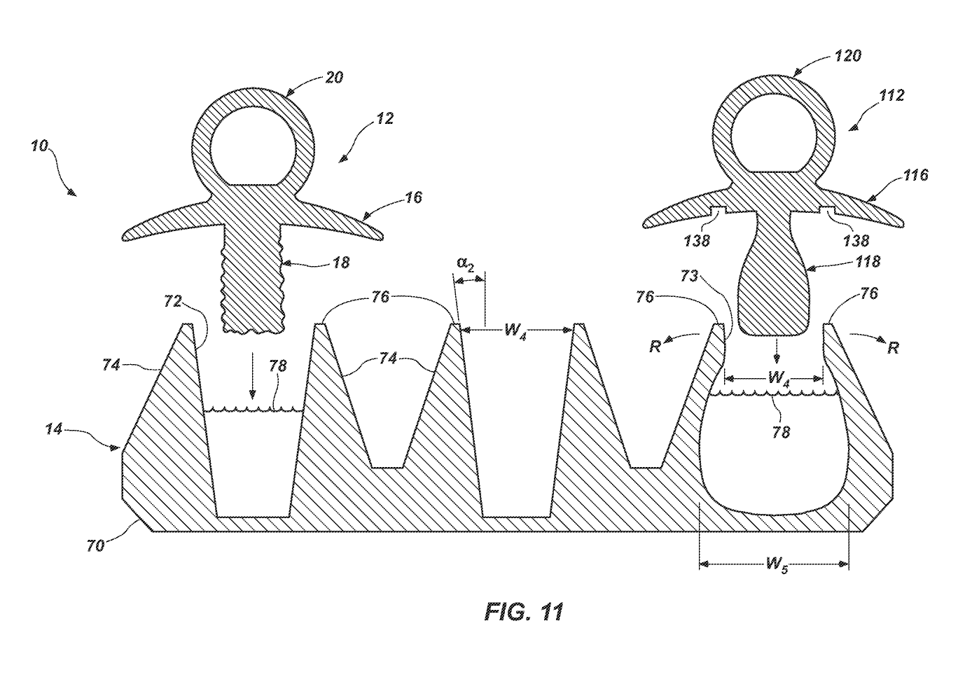

Referring now to FIG. 11, the mold 14 includes a base 70, a plurality of mold cavities 72, 73, a plurality of mold sidewalls 74, and a plurality of pacifier interfaces 76. The mold cavities 72, 73 may be configured to receive a liquid 78 that at least partially fills the mold cavities 72, 73. Portions of the pacifiers 12, 112 (e.g., the teething member 18, 118) are inserted into the mold cavities 72, 73, respectively. The pacifiers 12, 112 contact the pacifier interface 76 to support the pacifiers 12, 112 while the liquid 78 is frozen to form the frozen members 22, 122. The pacifier interface 76 may be defined at least in part by an uppermost surface of the mold sidewalls 74 adjacent to openings into the mold cavities 72, 73. In other arrangements, the pacifier interface 76 may be positioned at other locations along the mold sidewall 74 or within the mold cavities 72, 73.

The pacifier interface 76, alone or in combination with, for example, the alignment recesses 138 or other alignment features on the pacifiers 12, 112, may align the teething members 18, 118 within the mold cavities 72, 73 while the liquid 78 is being frozen. The pacifier interface 76 may also provide a releasable connection between the pacifiers 12, 112 and the mold 14. This releasable connection may provide a sealed connection that inhibits leakage of the liquid 78 after the pacifier system 10 is assembled and prior to the liquid 78 being frozen. Numerous types of alignment and securing features may be used at an interface between the pacifiers 12, 112 and the mold 14.

The liquid 78 may comprise any desired ingredient. In one example, the liquid 78 is filtered water. In other examples, the liquid 78 comprises juice, electrolytes, medications, or nutritional supplements. The liquid 78 may comprise a gel, semi-liquid or semi-solid material. The liquid 78 may be pre-cooled or at least partially frozen prior to insertion of the teething members 18, 118 into the mold cavities 72, 73. The liquid 78 may be frozen using any desired method such as, for example, exposure to temperatures of a standard freezer, or application of a super-cooled liquid such as liquid Nitrogen.

The mold cavities 72, 73 may, in one example, have a volume of about 5 mL to about 20 mL, and more preferably in the range of about 10 mL to about 15 mL of liquid. The amount of liquid held in the mold cavities 72, 73 may vary depending on, for example, the size of the teething member 18, 118 to be inserted therein, which displaces the liquid 78 within the mold cavity.

The mold cavities 72 may have a taper shape with a taper angle α₂. The taper angle α₂ may be in the range of, for example, about 2° to about 20°, and more preferable in the range of about 2° to about 10°. The tapered shape of the mold cavities 72 may promote easy removal of the frozen pacifier 13 from the mold 14.

Various materials, such as polymer-based materials, are possible for use in the pacifier system 10. In one example, at least the teething member 18 comprises a silicon material such as, for example, a 45 durometer food grade silicon. An example of such silicon material is the QM245 silicon material sold by Quantum Silicon of Richmond, Va. Other portions of the pacifier 12 such as the face shield 16 and handle 20 may comprise such silicon material. Other types of silicon such as medical grade silicon may be used in portions of the pacifier that do not interface with the mouth or face of the child. The mold 14 may also comprise silicon materials or other polymer materials that are easily cast or molded into the shape of mold 14. According to one exemplary embodiment, the mold 14 may be manufactured from a FDA approved food grade material, one example of which is 245.

According to one exemplary embodiment, the pacifier system 10 may be manufactured from a medical grade and FDA approved food grade silicone/polymer due to its contact with the mouth. Exemplary medical grade and FDA approved food grade silicone/polymers include, but are in no way limited to, MED-6382 silicone elastomer and MED-6010 silicone elastomer.

In at least one example, the mold 14 comprises materials that provide flexibility of the mold cavities 72, 73. FIG. 11 shows the mold cavity 73 being expandable radially outward in the direction R to increase a size of the opening into the mold cavity 73. This elastic deformation of the mold cavity 73 may promote removal of the frozen member when the frozen member has a negative angled shape (e.g., the bulbous shape of mold cavity 73 having a width W₅ that is greater than an inlet width W₄ of the opening into the mold cavity 73).

Another aspect of the present disclosure relates to providing a packet of frozen pacifiers that includes at least one frozen pacifier positioned within an enclosed packaging such as a disposable plastic package. The packaging may be sized to hold a plurality of frozen pacifiers. A plurality of individually packaged frozen pacifiers may be held within a greater sized package. In other arrangements, a pacifier system includes a plurality of pacifiers and at least one mold packaged together as a kit. The purchaser may form their own frozen pacifiers by filling the mold cavities of the mold with a liquid, inserting the teething member of the pacifier into the mold cavity, and freezing the liquid to form a frozen pacifier having a frozen member mounted to the teething member of the pacifier.

An example method of forming a frozen pacifier using the pacifier system 10 may include at least partially filling the mold cavity 72 with a liquid 78, inserting the teething member 18 into the mold cavity in contact with the liquid 78, freezing the liquid 78 to form a frozen member 22, and removing the pacifier 12 with frozen member 22 from the mold cavity 72 with the frozen member 22 connected to the teething member 18. The frozen member 22 may then be used to treat a child (e.g., inserting the frozen member 22 into the child's mouth). The child may chew on the teething member 18 after removal of the frozen member 22 (e.g., by melting the frozen member 22 within the child's mouth).

The method may include deforming a portion of the mold to remove the frozen member 22 from the mold. The method may include providing the pacifier with a face shield and handle in addition to the teething member. The face shield may have a contoured surface. The teething member may include a plurality of projections for recesses on an outer surface thereof that enhance its function as a teething member and provide connection of the frozen member 22 to the teething member 18. The handle 20 may include a loop structure having a handle opening.

The preceding description has been presented only to illustrate and describe exemplary embodiments of the system and process. It is not intended to be exhaustive or to limit the system and process to any precise form disclosed. Many modifications and variations are possible in light of the above teaching. It is intended that the scope of the system and process be defined by the following claims.

What is claimed is:

1. A pacifier system, comprising:
a pacifier, comprising:
a face shield having a first side and a second side, the first side having a concave surface;
a teething member extending from the concave surface on the first side of the face shield;
a handle extending from the second side of the face shield;
a frozen member mold, comprising a cavity sized to hold a volume of frozen fluid and receive the teething member held within the frozen fluid, the teething member being configured to maintain connection with the frozen fluid;
wherein the pacifier is removable from the frozen member mold with the frozen fluid attached to the teething member;
wherein the frozen fluid is insertable into a child's mouth to pacify the child and the teething member is configured to be chewed after the frozen fluid is removed.

2. The pacifier system of claim 1, wherein the teething member comprises a plurality of protrusions on an exterior surface thereof

3. The pacifier system of claim 1, wherein the frozen fluid has a tapered shape.

4. The pacifier system of claim 1, wherein the cavity has a nipple shape.

5. The pacifier system of claim 1, wherein the handle comprises a loop shaped portion.

6. The pacifier system of claim 1, wherein the face shield is configured to contact an outer facial surface of the child when the frozen fluid is inserted into the child's mouth.

7. The pacifier system of claim 1, wherein the frozen member mold comprises a plurality of cavities.

8. The pacifier system of claim 1, wherein the teething member comprises food grade silicone.

9. The pacifier system of claim 1, wherein the cavity is bulbous shaped.

10. The pacifier system of claim 1, wherein the frozen member mold further includes a pacifier interface configured to orient the teething member within the cavity.

11. A pacifier, comprising:
a face shield having a first side and a second side, the first side configured to contact lips or a facial surface of a child adjacent to a mouth of the child;
a teething member extending from the first side of the face shield, the teething member having an exterior surface;
a handle extending from the second side of the face shield, the handle comprising a grasping portion;
a frozen fluid mounted to the exterior surface of the teething member, the frozen fluid having a nipple shape;
wherein the teething member has a structure that retains the frozen fluid on the exterior surface of the teething member.

12. The pacifier of claim 11, wherein the teething member comprises a plurality of protrusions formed on the exterior surface thereof

13. The pacifier of claim 11, wherein the frozen fluid comprises at least one of a medication, a flavor, a color, water, and a juice.

14. The pacifier of claim 12, wherein the teething member comprises silicone.

15. The pacifier of claim 14, wherein the first side comprises a concave surface and a plurality of holes formed in the concave surface.

16. The pacifier of claim 15, wherein the pacifier is integrally formed as a single piece.

17. A method of manufacturing a frozen pacifier, comprising:
forming a pacifier that includes a face shield, a teething member extending from a first side of the face shield, and a handle extending from a second side of the face shield;
forming a mold comprising a mold cavity, the mold cavity being configured to be filled with a liquid and to receive the teething member, the liquid being frozen to form a frozen liquid that is secured to the teething member, the frozen liquid being removable from the mold cavity while secured to the teething member and configured for insertion into a child's mouth, the teething member being configured to be chewed within the child's mouth after the frozen liquid is removed from the teething member.

18. The method of claim 17, further comprising releasably connecting the pacifier to the mold while freezing the liquid.

19. The method of claim 17, further comprising elastically enlarging the mold cavity before removing the frozen liquid from the mold cavity.

20. The method of claim 17, further comprising forming the frozen liquid with a bulbous shape.

21. A method of using a pacifier system, comprising:
providing a pacifier and a mold, the pacifier including a face shield, a teething member extending from a first side of the face shield, and a handle extending from a second side of the face shield, the mold comprising a mold cavity having a shape of a nipple sized to fit within a child's mouth;
filling the mold cavity with a liquid;
inserting the teething member into the mold cavity;
freezing the liquid into a frozen liquid, the frozen liquid being secured to the teething member;
removing the teething member with the frozen liquid from the mold cavity;
inserting the frozen liquid into the child's mouth to treat the child's mouth;
removing the frozen liquid;
chewing on the teething member within the child's mouth after removing the frozen liquid.

22. The method of claim 21, wherein removing the frozen liquid includes thawing the frozen liquid in the child's mouth.
